(19) United States
(12) Patent Application Publication
(10) Pub. No.: US 2006/0029339 A1
(43) Pub. Date: Feb. 9, 2006

(54) Method and device for splicing of optical wave guides by fusion

(76) Inventor: Silvio Marazzi, Locarno (CH)

Correspondence Address: NATH & ASSOCIATES, 112 South West Street, Alexandria, VA, 22314, US

(21) Appl. No.: 10/531,318

(22) PCT Filed: Sep. 3, 2003
(86) PCT No.: PCT/CH03/00598

§ 371 Date: Apr. 13, 2005

(30) Foreign Application Priority Data
Oct. 14, 2002 (CH) 1705/02

(51) Int. Cl. G02B 6/255

(52) U.S. Cl. 385/96

(57) ABSTRACT

The inventive method consists in introducing two connectable end sections of spliceable optical waveguides in a mobile clamping device and in clamping said end sections in such a way that they are oriented at least towards one position which is axial with respect to another. Each clamping device (4, 4′) can slide along an advancing trajectory (5, 5′), said advancing trajectories being more or less in a parallel position to each other. During the advancement of the clamping devices, several processing stations arranged between said advancing trajectories can be sequentially actuated from preparatory operations followed by splicing operations which are carried out on said end sections at the level of the processing stations. The inventive processing stations comprise, in particular a wire skinning station (7), a cleaning station (8) and a length cutting station (9). By the end of the process, after the splicing operation, the spliced optical waveguide is removed from the clamping devices (4, 4′).

The invention relates to a method for splicing of optical waveguides by means of a fused joint, as claimed in the pre-characterizing clause of claim 1. In this case, optical waveguides are firmly connected to one another in such a way that light is transmitted through the splicing point with as little attenuation loss as possible.

Numerous splicing methods are already known and are in use. Thus, for example, WO 01/65288 describes an optical fiber splicing process in which the optical waveguides to be spliced first of all have two fiber stumps removed from them, which are spliced and measured as reference fibers. The end sections which are clamped in the same holding apparatus are spliced with the optimized measurement result from the reference fibers.

EP 1 174 744 describes a method and an apparatus for splicing of optical fibers having two or more optical waveguides which are arranged parallel alongside one another. The end sections are aligned with respect to one another on a monolithic holding block which is provided with V-shaped grooves, and are fixed with holding arms for splicing. For sequential splicing, the holding block is mounted on a movable table, so that the splicing points can be moved successively into the working area of a laser beam.

The known methods and apparatuses are not suitable for large-scale, automated production of spliced joints. Numerous manipulation operations, such as the cutting to length and cleaning of the end sections, have to be carried out manually, as in the past, which is associated with a large amount of time being required and leads to different spliced joint qualities depending on the care taken by the operator. Particularly for reference measurements, a large number of optical waveguides often have to be temporarily connected to the measurement apparatus by means of a spliced joint, with the splicing point being capped again after the measurement.

One object of the invention is thus to provide a method of the type mentioned initially, by means of which a large number of spliced joints can be produced with as constant a transmission loss as possible and in as short a time as possible. The required manipulation operations by the operator are intended to be reduced to a minimum, with the aim of as far as possible precluding manipulation errors. This object is achieved with regard to the method by a method which has the features in claim 1.

The mobile clamping holders, which can be moved approximately parallel to one another, make it possible to automate various working operations which are required for the spliced joint. In this case, two or more workstations which are arranged between the feed paths are approached sequentially, at which preparatory working operations are carried out on the end sections, and the splicing operation is finally carried out. The operator just has to ensure that the end sections are supplied to the clamping holders, where they are gripped with a clamping action and are aligned axially with respect to one another in at least one relative position. The entire work program is then carried out automatically and, at the end of the feed process, the spliced optical waveguide is removed from the clamping holders.

After a receiving station for gripping them with a clamping action, the end sections can be supplied successively to at least one stripping station, a cleaning station, a cutting-to-length station and a splicing station. These are the most important manipulation operations in conjunction with a spliced joint. However, it would also be feasible without any problems to arrange further workstations between the feed paths as well, for example a measurement station for carrying out specific measurements, or a marking station for marking the end sections.

The two clamping holders can be moved synchronously or asynchronously until the splicing operation. This allows great flexibility in the procedure.

The spliced optical waveguides can be placed in a holding palette for two or more optical waveguides at a storage station. This on the one hand results in organized storage while, on the other hand, the spliced points in the holding palette are largely protected against mechanical influences such as bending forces.

The end sections can be pulled by a motor into the clamping area of the clamping holder at a receiving station, and preferably be stretched before being gripped with a clamping action. This ensures that the end sections are always aligned in the same way.

The end sections are introduced between heating jaws and are heated at a stripping station, the outer casing is then cut into and is held firmly, and finally the end sections are separated from the outer casing by removal of the clamping holder by the stripping station, the remaining outer casing being thrown away from the stripping station. Separate stripping stations with heating jaws and stripping blades are admittedly already known per se. However, all the working operations involved must be carried out manually and they are not suitable for automatic processing.

Furthermore, the end sections can have a cleaning liquid and/or air applied to a subsection of them at a cleaning station, with the clamping holder being removed from the cleaning station in order to apply the cleaning liquid and/or air to the entire end section. In this case, the end section is treated with a cleaning liquid, and has dust and dirt particles removed from it, and is dried, by air pressure.

In order to achieve an optimum spliced joint, the end faces of the end sections to be connected must form a surface which is as planar as possible. For this purpose, the end sections are clamped in at a cutting-to-length station, are scored by a blade, and are broken by partial bending. The broken-off stumps are then passed out of the cutting-to-length station. Singular apparatuses are also already known for breaking the end sections, in which, however, all the work steps must likewise be carried out manually.

The invention also relates to an apparatus for splicing of optical waveguides by means of a fused joint, in particular in order to carry out the method mentioned initially, and having the features in claim 9.

The feed paths are in this case advantageously formed by guide rails, with the clamping holders each being mounted on one carriage which can be moved along the guide rails. However, it would, of course, also be feasible for the clamping holders to be arranged, for example, on a robot arm which moves them on virtual feed paths.

In order to optimize the procedures, the clamping holders can advantageously be moved on three spatial axes, specifically in the horizontal direction along the feed paths, in the vertical direction transversely with respect to the feed paths, and to and away from the workstations. Additional guides and/or drives are required to carry out these movements, unless the movements are carried out on a robot arm with a number of degrees of freedom.

A receiving station for gripping the end sections with a clamping action may have at least one stationary clamping apparatus, and may have an insertion apparatus by means of which an end section can be clamped between the stationary clamps in the stretched state before it is transferred to a mobile clamping holder. The insertion apparatus may in this case have an insertion funnel for insertion of the end section, as well as a sensor for limiting the insertion movement. A pulling-in roller pair, which is driven by a motor or motors, could also be used for insertion of the end section. This arrangement ensures that one end section is always gripped by the clamping holder in an exactly defined and aligned relative position. This is of major importance for carrying out the preparatory work steps and for the actual splicing process.

A stripping station may have a pair of heating jaws, at least one stripping blade and at least one throwing-out lever for throwing out the pulled-off outer casing. The heating jaws allow or make it easier to pull the outer casing off, and the throwing-out lever ensures that the stripping station is ready to pick up the next end section. In certain cases, suction or pressure nozzles could also be used instead of the throwing-out lever in order to remove the pulled-off outer casing by means of a flow.

A cleaning station for cleaning an end section may have at least one pair of cleaning jaws, through which the end section can be passed by means of a relative movement of the clamping holder, and at which a cleaning liquid and/or air can be applied to the end section. The cleaning jaws may in this case have a liquid section and an air section alongside one another, in which case the end section can first of all be passed through the liquid section and then through the air section, in at least two cyclic operations. It is also feasible for the end section to be passed through repeatedly on the same axis, with the same medium or different media being applied to it.

A cutting-to-length station may have a pair of cutting-to-length jaws for fixing the end section, a scoring blade which can be moved transversely with respect to the end section, and a breaking finger which can be pressed against the end section, wherein at least the relative movements of the cutting-to-length jaws and scoring blade can be controlled via a cam transmission. It is already known per se that an optimum end surface can be achieved by scoring being carried out transversely with respect to the optical axis of the optical waveguide and by subsequent breaking by means of a bending operation. For automation of the cutting-to-length operation, it is necessary for the various relative movements always to be carried out exactly and uniformly. This is ensured in a particularly optimum manner by the cam transmission.

The breaking finger may in this case be guided in the upper breaking jaw and, for example, may be operated mechanically or pneumatically.

A movable transport holder may be arranged above the workstations, by means of which the spliced optical waveguides can be picked up from the splicing station and can be transported to a storage palette which is preferably mounted above the receiving station where they can be stored.

Further individual features and advantages of the invention will become evident from the following description of one exemplary embodiment, and from the drawings, in which:

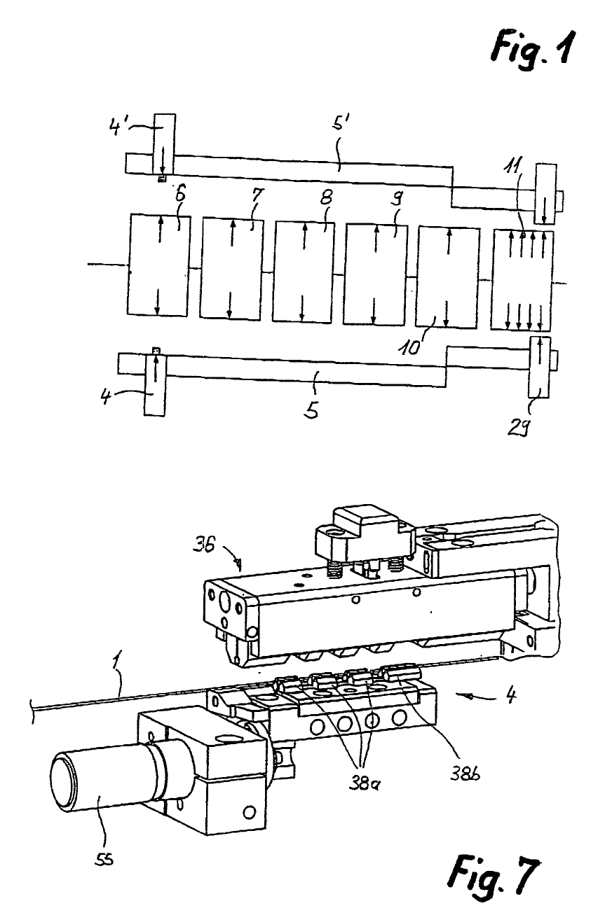

FIG. 1 shows a schematic illustration of the basic principle of an apparatus according to the invention,

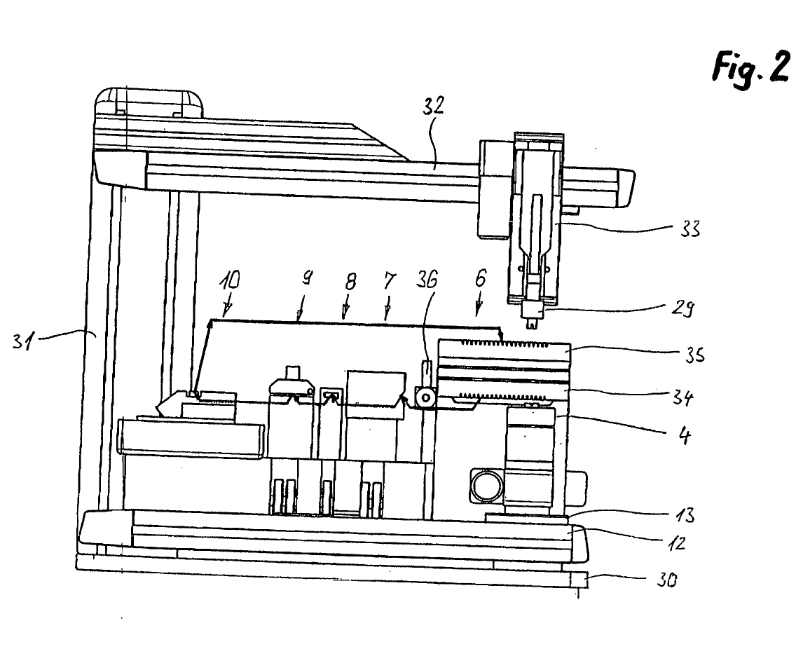

FIG. 2 shows a side view of an apparatus according to the invention having various work stations,

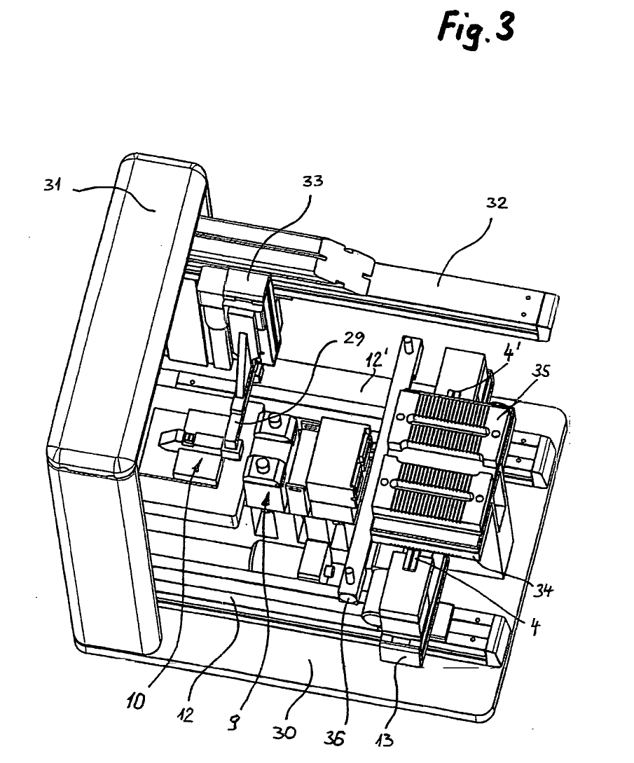

FIG. 3 shows a perspective illustration of the apparatus as shown in FIG. 2, from above,

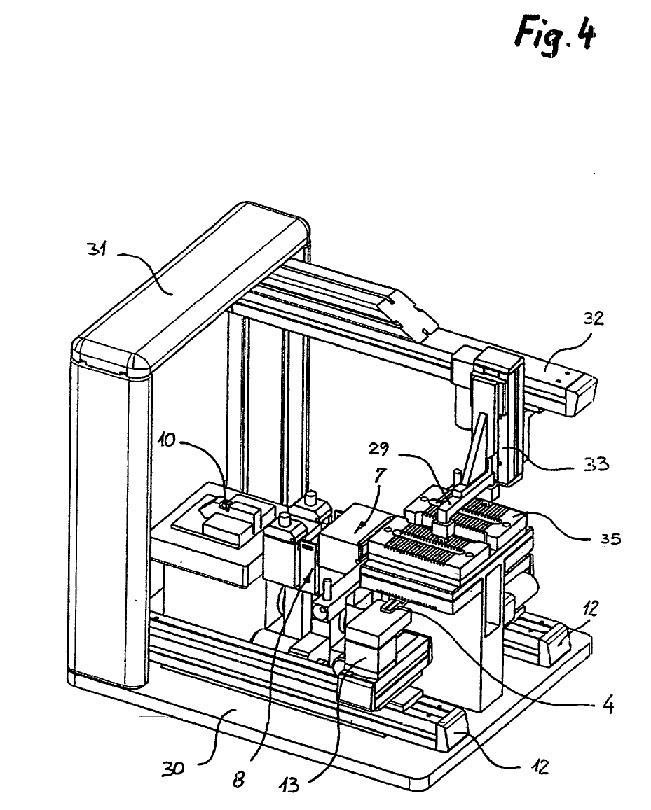

FIG. 4 shows a perspective illustration of the apparatus as shown in FIG. 2, from the front,

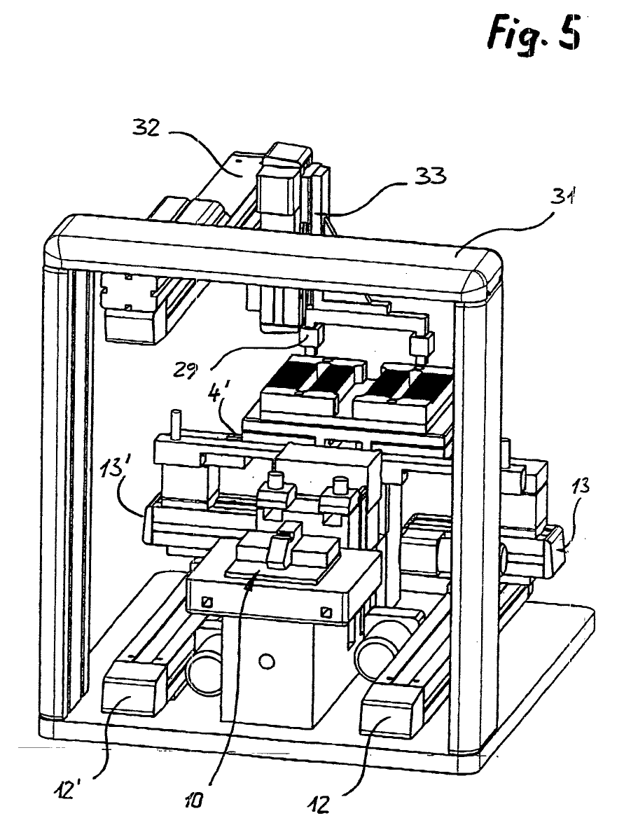

FIG. 5 shows a perspective illustration of the apparatus as shown in FIG. 2, from the rear,

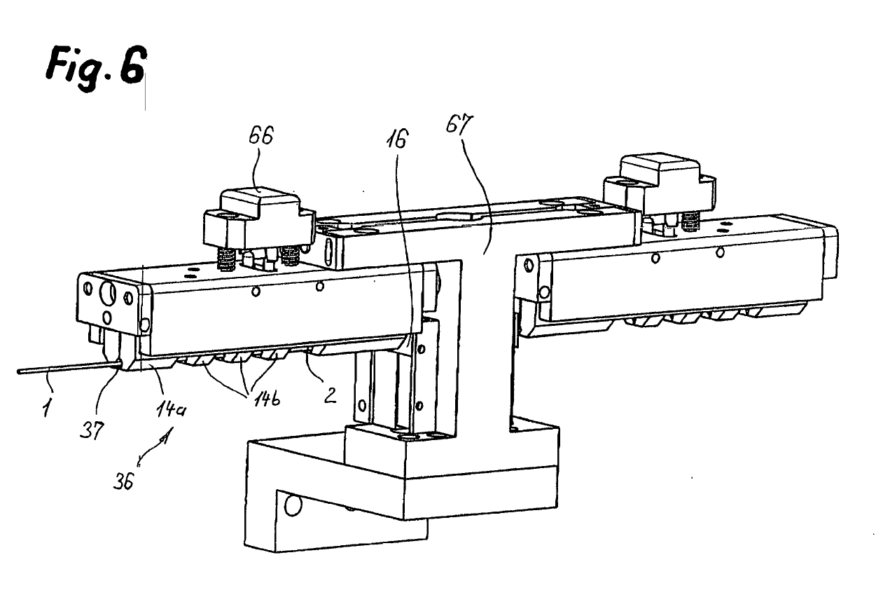

FIG. 6 shows a perspective illustration of an insertion apparatus at a receiving station,

FIG. 7 shows a perspective illustration of a mobile clamping holder at a receiving station,

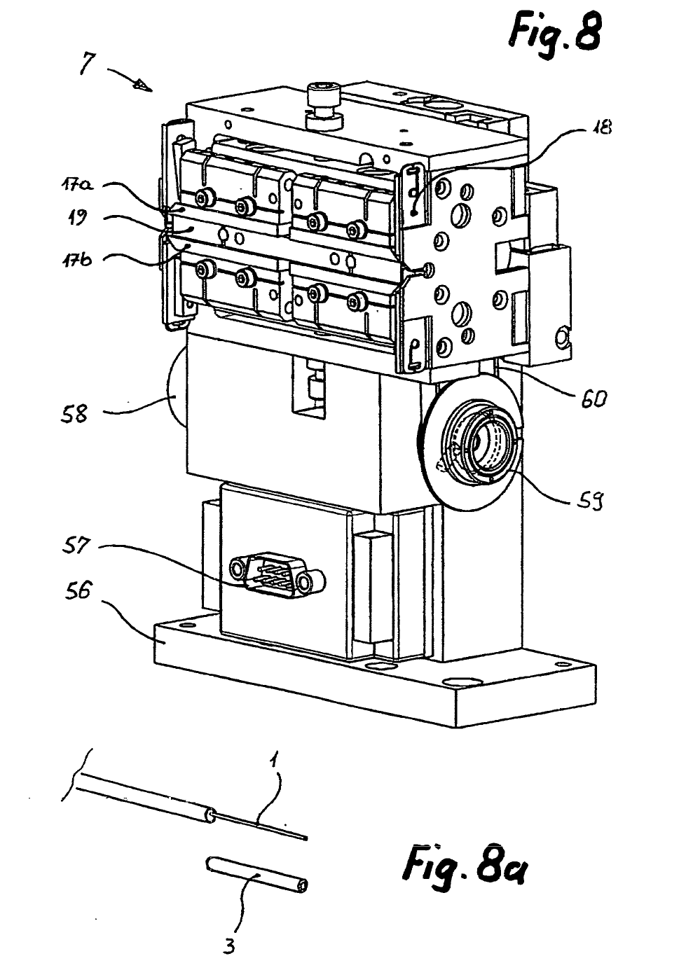

FIG. 8 shows a perspective illustration of a stripping station,

FIG. 8a shows a stripped end section of an optical waveguide,

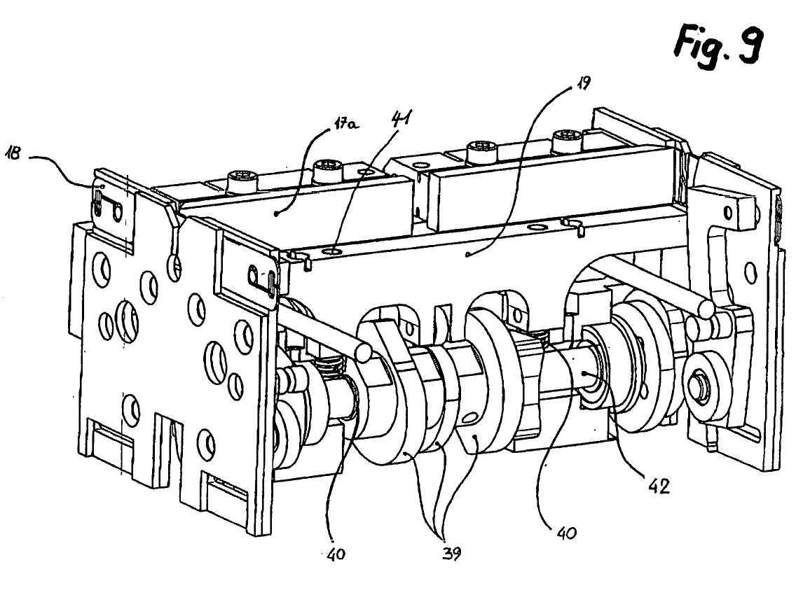

FIG. 9 shows a perspective internal view of the stripping station as shown in FIG. 8,

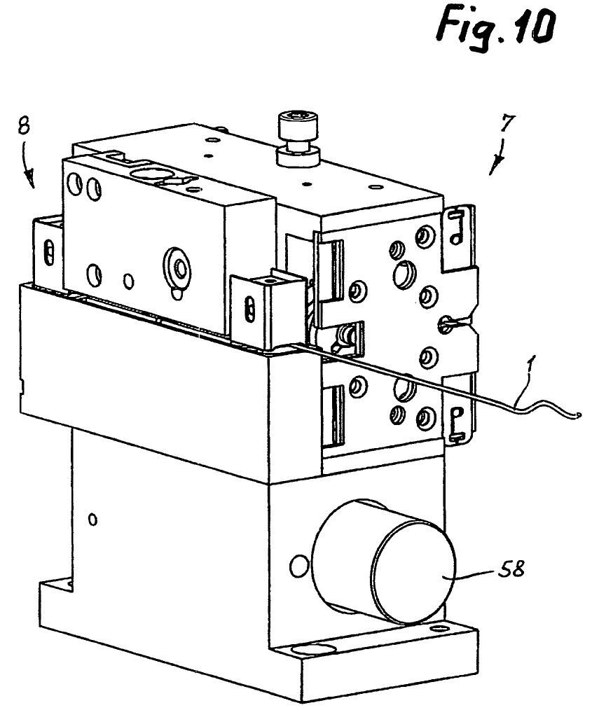

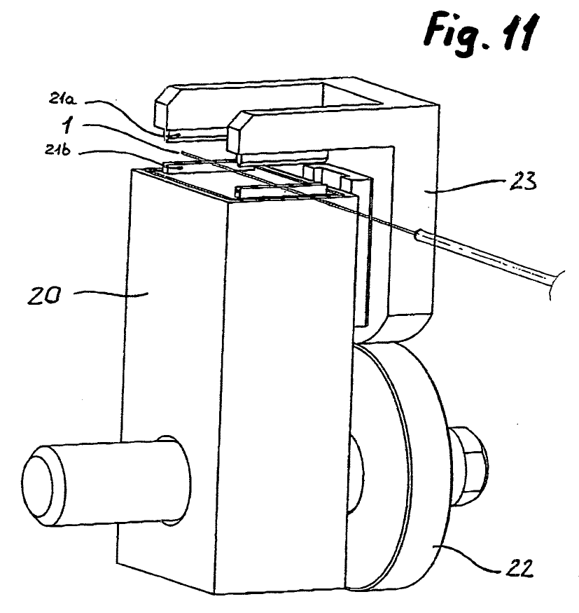

FIG. 10 shows a perspective illustration of the stripping station as shown in FIG. 8, looking at the fitted cleaning station,

FIG. 11 shows a perspective detailed illustration of the cleaning station,

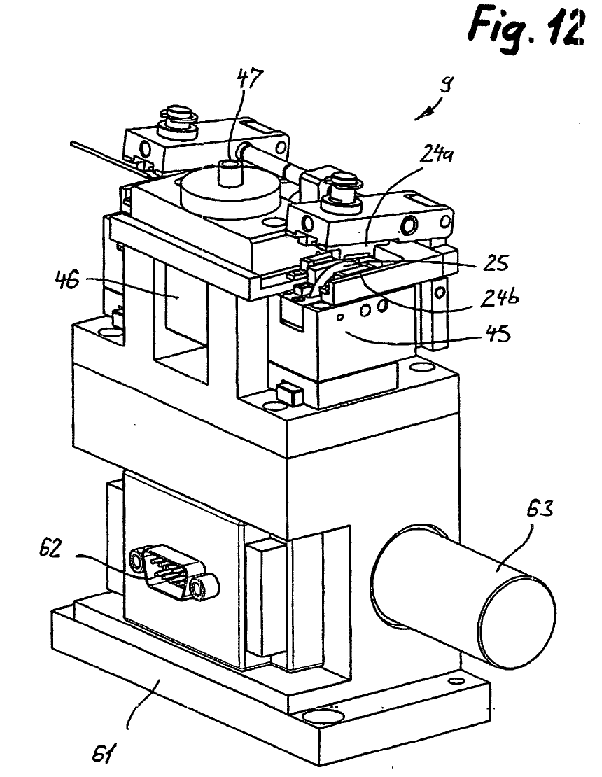

FIG. 12 shows a perspective illustration of a cutting-to-length station,

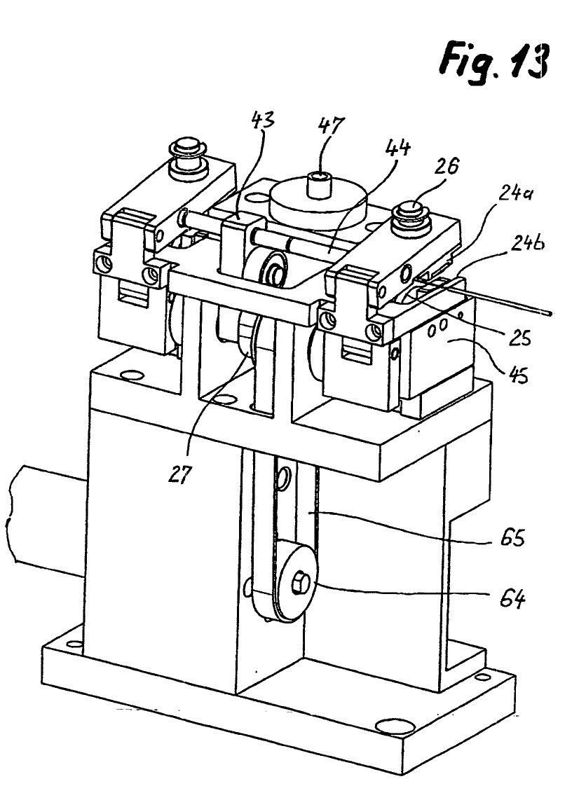

FIG. 13 shows the cutting-to-length station as shown in FIG. 12 from a different viewing direction, and

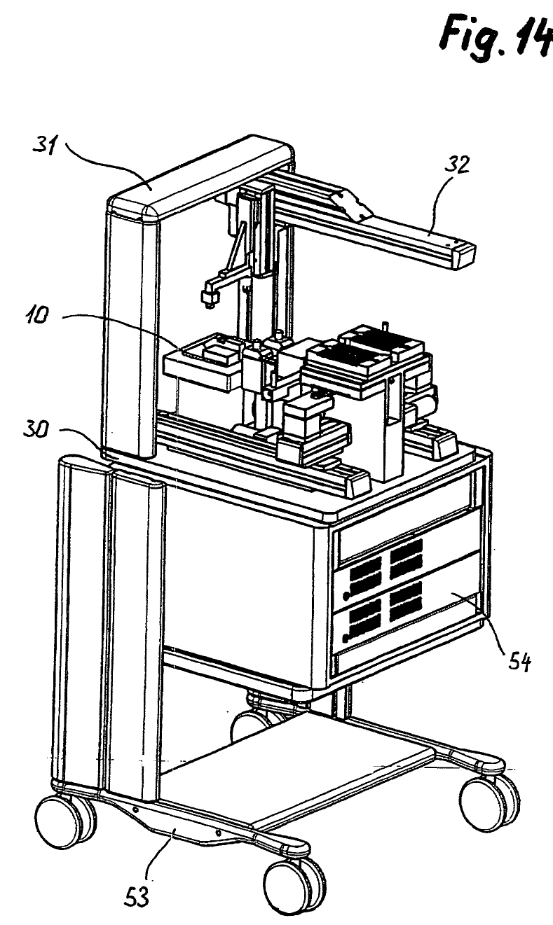

FIG. 14 shows a perspective illustration of a splicing apparatus with a control apparatus on a mobile rolling carriage.

FIG. 1 shows, schematically, a plan view of an apparatus according to the invention having two feed paths 5, 5′, which are arranged approximately parallel to one another and on each of which a clamping holder 4, 4′ can be moved forwards. Various workstations are arranged between the feed paths, to be precise, following a receiving station 6 for gripping the end sections of the optical waveguides with a clamping action, a stripping station 7, a cleaning station 8, a cutting-to-length station 9 and a splicing station 10. The various stations can be approached sequentially by the clamping holders 4, 4′, to be precise either synchronously or asynchronously. After the splicing operation, the optical waveguides can be transported from the splicing station 10 to a storage station 11, and can be stored. This is preferably done with the aid of a separate transport holder 29, in which case the storage station 11 may also once again be arranged at the start, in the area of the receiving station 6.

One specific embodiment of an apparatus according to the invention is illustrated in FIG. 2 and in FIGS. 3 to 5. Two parallel rails 12, 12′ are arranged on a base plate 30, with a clamping holder 4, 4′ being mounted on a carriage 13, 13′ on each of them. The receiving station 6, the stripping station 7, the cleaning station 8, the cutting-to-length station 9 and the splicing station 10 are arranged between the two rails 12, 12′.

The receiving station 6 has two different means for providing end sections of optical waveguides. These can be taken from an output palette 34 in which two or more end sections are inserted. The individual end sections may in this case be gripped with a clamping action from underneath, and may be removed from the output palette 34. Alternatively, individual end sections may be introduced into an insertion and clamping apparatus 36, from where they are removed with the aid of the clamping holders 4, 4′.

A yoke-like frame 31 is arranged on the base plate 30, to whose yoke arc a cantilever arm 32 is attached. A lifting carriage 33 is guided on this cantilever arm, and itself supports the transport holder 29. After the splicing operation at the splicing station 10, the spliced optical waveguide can be removed with the aid of the transport holder 29, and can be placed in a storage palette 35. In contrast to the output palette 34, the openings in the storage palette are directed upwards, so that the lifting carriage 33 can insert the optical waveguides with a vertical movement. While the output palettes 34 may be separate palettes, the storage palettes 35 are firmly connected to one another on a common base plate. During operation of the apparatus with the cassettes, the manual actions by the operator are restricted, as can be seen, to the loading of the cassettes 34 with the end sections and to the removal of the cassettes 35 with the spliced optical waveguides. All the other procedures are carried out automatically for a specific number of spliced joints.

The transport holder 29 likewise admittedly has two separate clamps. However, in contrast to the two clamping holders 4, 4′, these can be moved only synchronously since, after the splicing operation, the two spliced end sections may only be held and moved coaxially. As can be seen in particular from FIG. 3, the storage palettes 35 have a longitudinal slot in the center, which allows the clamps on the transport holder 29 to be lowered.

As can be seen from FIG. 3, the transport holder 29 is arranged in the area between the cutting-to-length station 9 and the splicing station 10, and, as can be seen from FIG. 4, it is located immediately above the storage palettes 35.

FIG. 6 shows an insertion apparatus 36 for pulling in an optical waveguide 1. This is inserted manually at an insertion funnel 37, which is in the form of a stationary clamp 14a. As soon as the end section 2 of the optical waveguide has reached the operating area of a stop with a sensor 16, the optical waveguide is automatically clamped in at the stationary clamps 14a and 14b. Two identical insertion apparatuses 36 are arranged in a mirror-image form, corresponding to the two parallel feed paths, on a T-shaped support 67. A release button 66 is arranged on each insertion apparatus, and pushing down on the release button 66 allows the stationary clamps 14a and 14b to be opened in order to release the optical waveguide again.

The optical waveguide which has been clamped in in this way can now be carried away by the clamping holder 4 as shown in FIG. 7, which has two or more clamping jaws 38a and 38b arranged at a distance apart. These clamping jaws are arranged, as can be seen, such that they can grip between the clamping jaws 14a and 14b of the insertion apparatus 36, in order to transfer the optical waveguide. The clamping jaws are operated by an electric motor 55 in a suitable manner via an eccentric transmission. In particular, a toggle lever closure would also be feasible, which is clamped at the receiving station and is released again after the splicing process at the splicing station. An end section 2 which has been gripped with a clamping action such as this is transported by means of the clamping holder to the first workstation, specifically to the stripping station 7.

FIGS. 8 and 9 show details of the stripping station 7. The entire arrangement is designed as a module on its own base plate 56. The module has an interface 57 for electrical connections, and has its own electric motor 58 which drives the moving parts of the stripping station via a pulley disk 59 and a belt 60. The aim of the stripping station is to remove any outer casing 3 surrounding the actual optical waveguide 1 (FIG. 8a). A pair of heating jaws 17a, 17b are provided for this purpose, which can be opened and closed and can be heated by means of a heating device (for example heating wires incorporated in the heating jaws), which is not illustrated. The outer casing 3 is cut into at a stripping blade 18, so that it can be pulled off the end section of the optical waveguide, in the heated state.

FIG. 9 shows a stripping station which is open and has been rotated through 90° with the lower heating jaws 19b having been removed. The figure in this case shows a frontal view of the heating surfaces of the upper heating jaws 17a.

FIG. 9 also shows that a throwing-out lever or throwing-out bar 19 is arranged within the stripping station 7, behind the heating jaws 17a, 17b which can be fed from the side. This throwing-out lever or throwing-out bar 19 can be moved parallel to the clamping plane of the heating jaws on guide rods 41, so that it ejects into the space between the open jaws. In the neutral initial position, the throwing-out lever 19 is pulled back by resetting springs 40.

The movement of the heating jaws and of the throwing-out lever 19 takes place via a cam transmission with cam disks 39 which are arranged on a control shaft 42. The latter is driven via the belt 60 (FIG. 8). The movement sequences are in this case programmed in such a way that the heating jaws 17a, 17b first of all close after an end section has been inserted from the side, and remain closed for a specific time during which the heat acts. In the course of the closing movement, the stripping blade 18 at the same time makes the incision in the outer casing 3. Once the end section has been pulled out of the closed heating jaws, they open and the remaining outer casing is thrown out by the throwing-out lever 19.

FIG. 10 shows the stripping station 7, once again, from a different viewing angle, specifically looking at the motor 58. A cleaning station 8 is likewise fitted directly to the stripping station 7, in the form of an autonomous module. Details of the cleaning station are illustrated in a highly simplified form in FIG. 11. The cleaning station essentially comprises a pair of cleaning jaws or twin jaws 21a, 21b. These have a liquid section which, for example may have a layer with a suction capability which is permanently impregnated with a cleaning liquid. The end section of the optical waveguide is passed through the cleaning station 8 in two sequences, with the cleaning jaws 21a, 21b being opened and closed each time. The jaws are in this case open in each case only for the insertion of the end section, and they remain closed until the end section is pulled back. It would likewise be feasible to use, for example, a nozzle to dry the optical waveguide (which has been cleaned with the aid of the cleaning liquid) in a separate section.

The cleaning jaws are likewise operated via a cam disk 22, which presses a clamping jaw carriage 23 upwards against spring preloading in order to open the clamping jaws. The lower clamping jaws 21b are arranged fixed on the housing 20.

FIGS. 12 and 13 illustrate details of a cutting-to-length station 9. In a similar way to the stripping station 7, the cutting-to-length station 9 is also an autonomous module, having a base plate 61 and an interface 62 for electrical connections. The electric motor 63 drives a pulley disk 64 and a belt 65 in order to control the various movement sequences via a cam transmission. As in the case of the stations described above, these movement sequences also take place in the cutting-to-length station for both sides, that is to say simultaneously for both optical waveguide ends to be processed.

The cutting-to-length station has cutting-to-length jaws 24a, 24b, with the upper cutting-to-length jaw 24a being attached in an articulated manner on one side to the U-shaped lower cutting-to-length jaw 24b. A scoring blade 25 is mounted on a slide 45 in the area between the U limbs of the lower cutting-to-length jaw 24b and can be moved by means of a ball transmission transversely with respect to the axis of the clamped-in optical waveguide.

The pivoting movement of the upper cutting-to-length jaw 24a relative to the lower cutting-to-length jaw 24b is produced via a lifting element 43 which is raised above the cam transmission 27 and is fitted with a lifting shaft 44. The lifting shaft is connected in an articulated manner to the upper cutting-to-length jaws 24a on both sides of the station.

A breaking finger 26 is mounted in the upper cutting-to-length jaw 24a such that it can move on the same plane as the clamped-in optical waveguide. This breaking finger 26 is pressed downwards against the optical waveguide after the slide 45 has been moved forward, that is to say after the scoring movement with the scoring blade 25, so that bending results in breakage at the scored point.

The broken-off length element of the optical waveguide falls into a holding container 46, which is subjected to a vacuum, via a vacuum connection 47.

The splicing station 10 is a module which is already known per se and has just been slightly adapted for the automation process, and with which those skilled in the art will already be familiar. As likewise already known and as is described, for example, in EP 1 174 744 as well, this includes a laser welding module, as well as a camera and a micromanipulator for observation and manipulation of the end surfaces to be welded. After centering with respect to one another in a V-shaped groove, the end surfaces are pushed close to one another and are then raised to the fusion temperature by the laser. The ends are then pressed together producing a fused joint, and are then pulled apart from one another again until the optical waveguide resumes its original diameter again.

FIG. 14 shows an apparatus according to the invention which is installed on a rolling carriage 53. A computer 54 is accommodated in this, in order to control all of the procedures. The computer controls the various electric-motor and pneumatic drive means. The apparatus also includes a screen, which is not illustrated here, for observation of the splicing processes, as well as a printer for printing out splicing records. With the exception of the splicing station 10, all of the work stations are, of course, duplicated, so that the stripping, cleaning and cutting-to-length can in each case be carried out synchronously or asynchronously on both of the end sections to be spliced.

1. A method for splicing of optical waveguides (1) by means of a fused joint, in which the two end sections (2) of the optical waveguides to be connected have any outer casing (3) removed from them, are cleaned and are cut to length before the splicing operation, characterized
in that the two end sections (2) are introduced into a respective mobile clamping holder (4, 4′) and are gripped with a clamping action by it in such a way that they are aligned axially with respect to one another in at least one relative position,
in that each clamping holder is moved along a feed path (5, 5′), with the feed paths running approximately parallel,
in that, in the course of the feeding of the clamping holders, two or more workstations (7, 8, 9, 10), which are arranged between the feed paths, are approached sequentially, at which the preparatory work operations and the splicing operation are carried out on the end sections,
and in that, at the end of the feed process, the spliced optical waveguide is removed from the clamping holders.

2. The method as claimed in claim 1, characterized in that, after a receiving station (6) for gripping them with a clamping action, the end sections (2) are supplied successively to at least one stripping station (7), a cleaning station (8), a cutting-to-length station (9) and a splicing station (10).

3. The method as claimed in claim 1 or 2, characterized in that the two clamping holders (4) are moved synchronously or asynchronously until the splicing operation.

4. The method as claimed in one of claims 1 to 3, characterized in that the spliced optical waveguides are placed in a holding palette for two or more optical waveguides at a storage station.

5. The method as claimed in one of claims 1 to 4, characterized in that the end sections are pulled by a motor into the clamping area of the clamping holder at a receiving station (6), and are preferably stretched before being gripped with a clamping action.

6. The method as claimed in one of claims 1 to 5, characterized in that the end sections are introduced between heating jaws and are heated at a stripping station (7), in that the outer casing is cut into and is held firmly, in that the end sections are separated from the outer casing by removal of the clamping holder by the stripping station, and in that the remaining outer casing is thrown away from the stripping station.

7. The method as claimed in one of claims 1 to 6, characterized in that the end sections have a cleaning liquid and/or air applied to a subsection of them at a cleaning station (8), with the clamping holder being removed from the cleaning station in order to apply the cleaning liquid and/or air to the entire end section.

8. The method as claimed in one of claims 1 to 7, characterized in that the end sections are clamped in at a cutting-to-length station (9), are scored by a blade and are broken by partial bending, and in that the broken-off stump is carried out of the cutting-to-length station.

9. An apparatus for splicing of optical waveguides by means of a fused joint, having a splicing station (10) at which the end sections (2) of the optical waveguides to be connected are clamped in such that they are aligned with one another, and can be connected to one another by the influence of heat, characterized by
at least two mobile clamping holders (4, 4′) for gripping the end sections with a clamping action, and which can be moved on approximately parallel feed paths (5, 5′) which are arranged at a distance from one another,
two or more workstations (7, 8, 9, 10), which are arranged between the feed paths and one of which is the splicing station (10),
wherein the clamping holders (4, 4′) can be moved to the workstations sequentially in order to carry out preparatory work operations on the end sections and in order to carry out the splicing operation.

10. The apparatus as claimed in claim 9, characterized in that, between the feed paths (5, 5′), a receiving station (6) for gripping the end sections with a clamping action is followed by at least one stripping station (7), a cleaning station (8), a cutting-to-length station (9) and the splicing station (10).

11. The apparatus as claimed in claim 9 or 10, characterized in that the feed paths (5, 5′) are formed by guide rails (12), and in that the clamping holders (4, 4′) are each mounted on one carriage (13) which can be moved along the guide rails.

12. The apparatus as claimed in one of claims 9 or 10, characterized in that the clamping holders can be moved on three spatial axes, specifically and preferably in the horizontal direction along the feed paths, in the vertical direction transversely with respect to the feed paths, and towards respectively away from the workstations.

13. The apparatus as claimed in one of claims 9 to 12, characterized in that a receiving station (6) has a stationary clamping apparatus for gripping the end sections (2) with a clamping action, and has an insertion apparatus by means of which an end section can be clamped in the clamping apparatus (14) in the stretched state before it is transferred to a mobile clamping holder.

14. The apparatus as claimed in claim 13, characterized in that the insertion apparatus has an insertion funnel for insertion of the end section, as well as a sensor (16) for limiting the insertion movement.

15. The apparatus as claimed in one of claims 9 to 14, characterized in that a stripping station (7) has a pair of heating jaws (17), at least one stripping blade (18) and at least one throwing-out lever (19) for throwing out the pulled-off outer casing.

16. The apparatus as claimed in one of claims 9 to 15, characterized in that a cleaning station (8) for cleaning an end section has at least one pair of cleaning jaws (21), through which the end section can be passed by means of a relative movement of the clamping holder, and at which a cleaning liquid and/or air can be applied to the end section.

17. The apparatus as claimed in one of claims 9 to 16, characterized in that a cutting-to-length station has a pair of cutting-to-length jaws (24) for fixing the end section, a scoring blade (25) which can be moved transversely with respect to the end section, and a breaking finger (26) which can be pressed against the end section, wherein at least the relative movements of the cutting-to-length jaws and scoring blade can be controlled via a cam transmission (27).

18. The apparatus as claimed in claim 17, characterized in that the breaking finger is guided in the upper breaking jaw.

19. The apparatus as claimed in one of claims 9 to 18, characterized in that a movable transport holder (29) is arranged above the workstations, by means of which the spliced optical waveguides can be picked up from the splicing station (10) and can be transported to a storage plate (35) which is preferably mounted above the receiving station (6) where they can be stored.
